(19) United States
(12) Patent Application Publication
(10) Pub. No.: US 2024/0149687 A1
(43) Pub. Date: May 9, 2024

(54) CONTENT DISPLAY DEVICE FOR ROAD VEHICLE AND RELATIVE ROAD VEHICLE

(71) Applicant: FERRARI S.P.A., Modena (IT)

(72) Inventors: Jonathan P. IVE, SAN FRANCISCO, CA (US); Eugene WHANG, SAN FRANCISCO, CA (US); Jeremy BATAILLOU, SAN FRANCISCO, CA (US); Anthony ASHCROFT, SAN FRANCISCO, CA (US); Suhang ZHOU, SAN FRANCISCO, CA (US); Benoit LOUZAOUEN, SAN FRANCISCO, CA (US); Jemima KISS, SAN FRANCISCO, CA (US); Christopher WILSON, SAN FRANCISCO, CA (US); Wan Si WAN, SAN FRANCISCO, CA (US); Biotz NATERA, SAN FRANCISCO, CA (US); James MCGRATH, SAN FRANCISCO, CA (US); Roger GUYETT, SAN FRANCISCO, CA (US); Joseph LUXTON, SAN FRANCISCO, CA (US); Michael MATAS, SAN FRANCISCO, CA (US); Patrick KESSLER, SAN FRANCISCO, CA (US); Patrizio MORUZZI, MODENA (IT); Vito CONIGLIARO, MODENA (IT)

(21) Appl. No.: 18/498,588

(22) Filed: Oct. 31, 2023

(30) Foreign Application Priority Data
Nov. 4, 2022 (IT) 102022000022668

(51) Int. Cl. B60K 35/55; B60K 35/28; B60K 35/53; B60K 35/60; B60K 35/65; G06F 3/14

(52) U.S. Cl. CPC B60K 35/55; B60K 35/28; B60K 35/53; B60K 35/60; B60K 35/654; B60K 35/656; G06F 3/1446; B60K 2360/166; B60K 2360/167; B60K 2360/182

(57) ABSTRACT

A content display device for a road vehicle comprising: a first support element; a second support element configured to be mounted at the dashboard in a position adjacent to the first support element; a first screen, mechanically connected to the first support element; a second screen, mechanically connected to the second support element; a movement system mechanically coupled to the first support element and to the second support element and configured to move the first screen and/or the second screen from a joint configuration, in which the first screen and the second screen are adjacent, to a disjointed configuration, in which the first screen and the second screen are separated from each other; in the disjointed configuration, the first screen being towards the driver and/or towards the passenger.

### CROSS-REFERENCE TO RELATED APPLICATIONS

This patent application claims priority from Italian patent application no. 102022000022668 filed on Nov. 4, 2022, the entire disclosure of which is incorporated herein by reference.

### TECHNICAL FIELD

The present invention concerns a content display device for a road vehicle and a relative road vehicle.

In particular, the present invention is advantageously, but not exclusively, applied in a content display device for a high-performance road vehicle, to which the following description will explicitly refer without loss of generality.

### BACKGROUND TO THE INVENTION

Generally, road vehicles are provided with a plurality of display devices arranged on the dashboard of the road vehicle.

Historically, each road vehicle comprises at least one display device for the driver, for example the screens or indicators arranged on the vehicle instrument panel, namely on the portion of dashboard interposed between the steering wheel and the windscreen.

In recent years, said devices can be assisted by other screens (for example at least one screen arranged centrally on the dashboard or a head-up display) which complete display of the information for the driver.

In general, the arrangement of an increasingly large central screen is becoming increasingly popular, especially in fully electric cars; however, in the majority of cases, said central screens are exclusively provided with touch controls, which during sports car driving (for example on the track) make it difficult, if not impossible, to select a function without distracting the driver. Furthermore, said screens are generally integral with the dashboard and therefore, whilst they are visible both to the driver and to the passenger, they do not provide an optimal view of the information for either of them both in terms of perspective and due to possible reflections (for example caused by the sun or the headlights of another vehicle), which considerably reduce the rapidity with which the driver can read said information.

In addition, although devices have been developed designed to be visible also to the passengers of road vehicles, said devices are generally associated with the rear seats, since it is difficult for a passenger sitting in the front seat, alongside the driver, to view distracting content such as films, documentaries, news, etc. without distracting the driver. For this reason, it is difficult for the front passenger to view distracting content via the central screen.

In recent years, to overcome the problem of driver distraction, the front passenger is allowed to view distracting content only with the vehicle at a standstill. During driving, on the other hand, the front passenger is allowed to view only content deemed to be non-distracting, for example the speed, route or other contents that aid driving (such as the current gear, lateral accelerations) which, for example, the driver can view via other screens.

However, said solutions limit the entertainment of the front passenger (namely the passenger sitting alongside the driver), reducing the pleasure of the ride.

In general, therefore, the need is felt to increase the flexibility of the vehicle display systems, allowing the driver to read the information more rapidly and, at the same time, enabling the passenger to view distracting content.

### DESCRIPTION OF THE INVENTION

The object of the present invention is to provide a content display device for a road vehicle and a relative road vehicle which are at least partially exempt from the drawbacks described above and, at the same time, are simple and inexpensive to produce.

According to the present invention, a content display device for a road vehicle and a relative road vehicle are provided as claimed in the following independent claims and, preferably, in any one of the claims depending directly or indirectly on the independent claims.

The claims describe preferred embodiments of the present invention forming an integral part of the present description.

### BRIEF DESCRIPTION OF THE DRAWINGS

Below, some embodiments of the invention will be described for a better understanding thereof by way of non-limiting example and with reference to the attached drawings in which:

FIG. 1 is a perspective and schematic view, with details removed for clarity, of a possible embodiment of a road vehicle in accordance with the present invention;

FIG. 2 is a perspective schematic view of part of the interior of the passenger compartment of FIG. 1 in which a central display device can be seen;

FIG. 3 is a frontal schematic view of part of the interior of the passenger compartment of FIG. 2 in which the central display device comprises two sliding portions in a first disjointed configuration; and

FIG. 4 is a frontal schematic view of the embodiment of FIG. 3 in which the two sliding portions are in a second joint configuration.

### EMBODIMENTS OF THE INVENTION

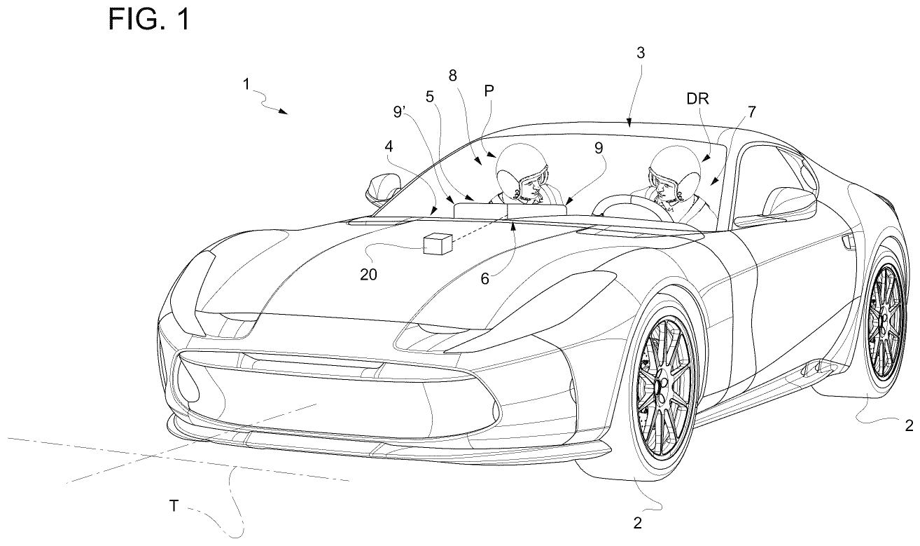

In FIG. 1, the number 1 indicates overall a road vehicle provided with two front wheels 2 and two rear wheels 2 (in particular driving wheels). The vehicle 1 is provided with a passenger compartment 3 which is adapted to house at least one driver DR and preferably one or more passengers P, of which at least one alongside the driver DR as illustrated in FIG. 1.

The same reference numbers and letters in the figures identify the same elements or components with the same function.

In the context of the present description the term “second” component does not imply the presence of a “first” component. Said terms are employed as labels to improve clarity and should not be understood in a limitative manner.

The elements and the characteristics illustrated in the different preferred embodiments, including the drawings, can be combined with or isolated from one another without departing from the protective scope of the present application as described below.

Furthermore, the road vehicle 1 comprises a frame (of known type and therefore not illustrated in detail), and a vehicle dashboard 4 inside the passenger compartment and fixed to the frame. The vehicle dashboard 4 is arranged frontally to the driver DR and to any passenger P.

As illustrated in the non-limiting embodiments of the attached figures, the road vehicle 1 comprises a content display device 5, which is arranged at the vehicle dashboard 4, in particular on a central portion 6 of the vehicle dashboard 4 between a driving position 7 and a passenger position 8.

The content display device 5 comprises a first support element 9, which is configured to be mounted at the dashboard 6 of the road vehicle 1, in particular at a central portion of the dashboard 6.

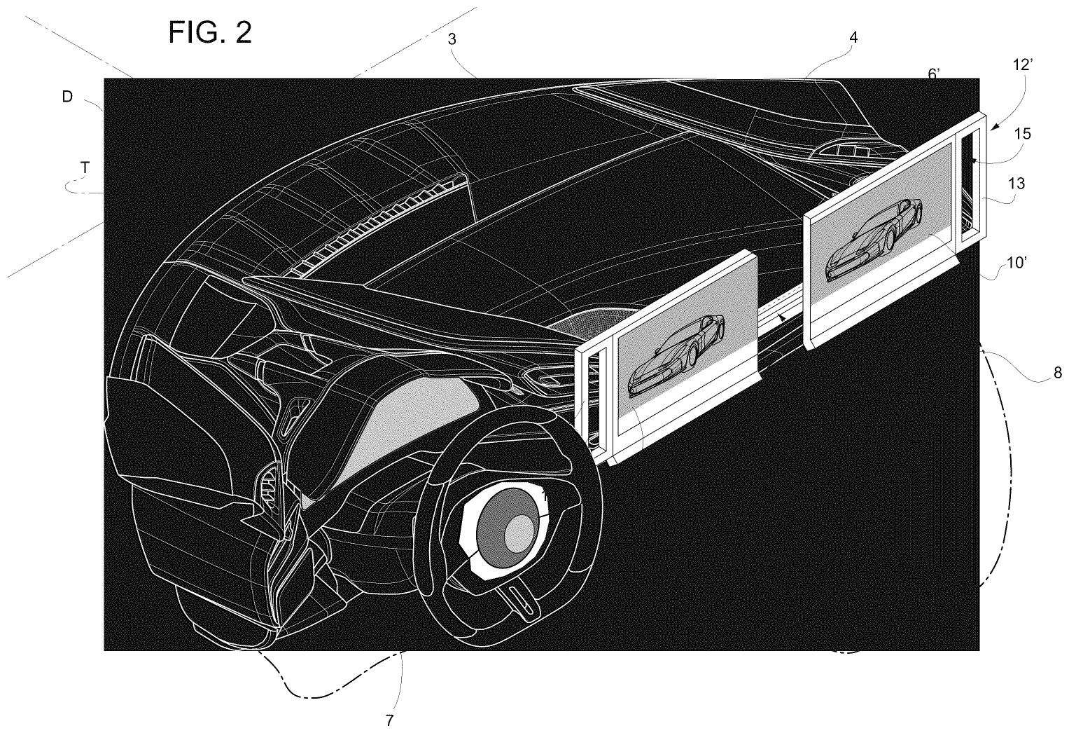

The content display device 5 further comprises a second support element 9′, configured to be mounted at the dashboard 4 in a position adjacent to the first support element 9. In particular, the support element 9 is arranged, with respect to a normal direction D of travel of the road vehicle 1, on the left of the support element 9′, which is therefore, in the non-limiting embodiment of FIGS. 2 to 4, nearer the driver DR.

The set of support elements 9, 9′, in other words, determines the main structure of the content display device 5, namely the portion on which the other components of the device 5 are mounted/assembled.

Furthermore, the display device 5 comprises a first screen 10, which is mechanically connected to and preferably integral with the first support element 9 and is configured to be visible to the driver DR and/or to the passenger P.

In addition, the display device 5 comprises a second screen 10′, mechanically connected to the second support element 9′ and configured to be visible to the passenger P and/or to the driver DR while driving.

The screen 10, 10′ is of known type (for example liquid crystal and preferably a touchscreen) and therefore is not further described below.

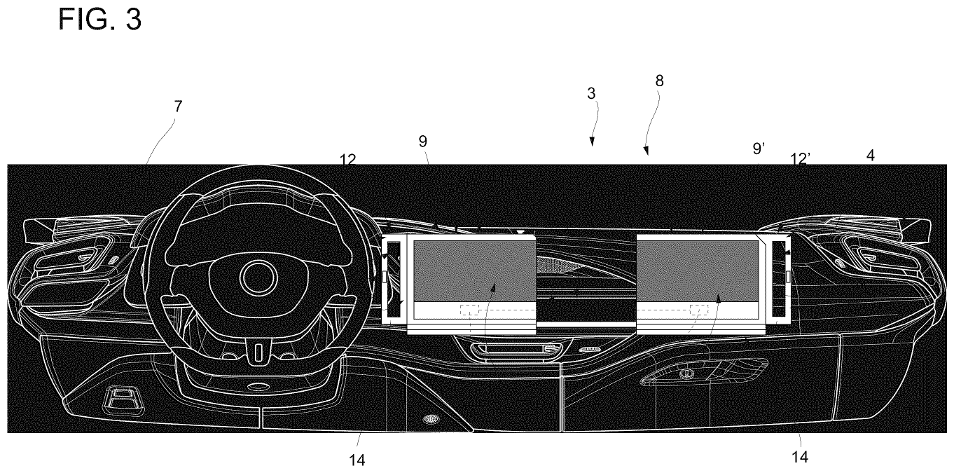

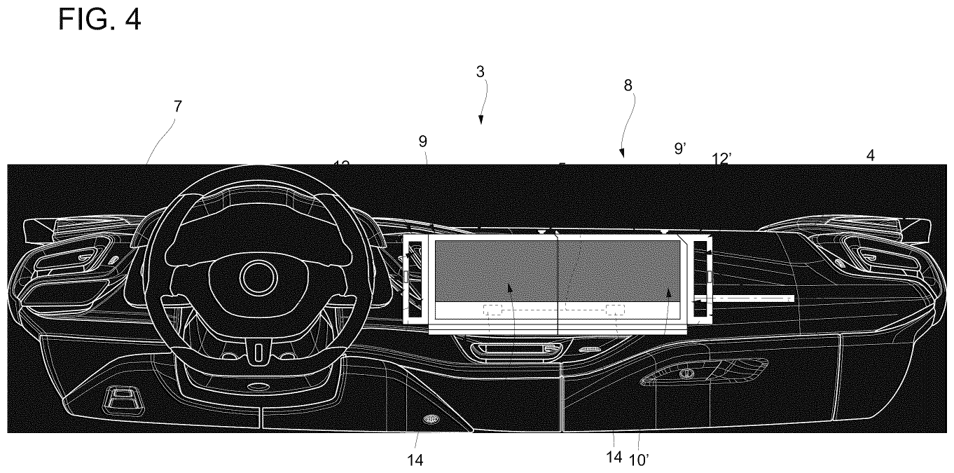

Advantageously, the content display device 5 comprises a movement system 11 which is, on one side, mechanically coupled to the support elements 9, 9′ and, on the other, is integrated in the dashboard 4, to move (preferably translate) the screens 10 and 10′ between a joint configuration (FIGS. 1 and 4), in which the first screen 10 and the second screen 10′ are adjacent, and a disjointed configuration (FIGS. 2 and 3), in which the first screen 10 and the second screen 10′ are separate from each other. In detail, without limitation, in the disjointed configuration, illustrated for example in FIGS. 2 and 3, the first screen 10 is nearer the driving position 7, while the second screen 10′ is arranged at a lateral portion 6′ substantially arranged frontally to the passenger position 8.

In some non-limiting cases, the movement system 11 is configured to move only the second screen 10′. In this way, the driver DR always has the screen 10 near his driving position 7 to view driving information or infotainment.

In other non-limiting cases, the movement system 11 is configured to move only the first screen 10. In this way, the passenger P can increase the dimension of the image displayed by combining the two screens and making the content displayed more immersive, whether it relates to driving or whether it is distracting (in this case, both the screens would be well away from the driver DR and frontal to the passenger P who can view them).

In further non-limiting cases, the movement system 11 is configured to move both the screens 10 and 10′ to allow the driver DR and the passenger P the preferred configuration, including intermediate configurations.

Advantageously but without limitation, the movement system 11 comprises at least one guide 18 arranged at a surface 19 of the dashboard 4.

Preferably, the guide 18 extends transversely to the normal direction D of advancement of the road vehicle 1, namely in a direction transverse to the direction D.

In detail, without limitation, the first support element 9 and the second support element 9′ are movably mounted and sliding along the guide 18.

Advantageously but without limitation, the guide 18 is rectilinear (namely linear) and extends in a direction parallel to a horizontal axis T (illustrated in FIGS. 1 and 2).

In particular, the movement system 11 is any structure or mechanism that allows the support elements 9, 9′ and therefore the screens 10, 10′ to pass from the joint configuration in which the screens 10, 10′ are alongside each other (and parallel, showing one single shared content) on the transverse axis T of the road vehicle 1 (namely the configuration of FIG. 4), to at least one disjointed configuration in which the screens 10 are separated from each other (and show the same content or independent content) (as illustrated in FIGS. 2 and 3).

In particular, therefore, the movement system 11 is configured to cause the support element 9 and the support element 9′ to translate between each other along an axis A at least partially, in detail totally, parallel to a floor F of the road vehicle 1.

Preferably but without limitation, the display device 5 comprises at least one first manipulation element 12 mounted integral with the first support element 9 and/or a second manipulation element 12′ mounted integral with the second support element 9′.

In particular, the first manipulation element 12 and/or the second manipulation element 12′ are configured to be grasped by a hand of the driver DR and/or of the passenger P to move, in particular to translate, between each other the first screen 10 and/or the second screen 10′ at least between the configuration in which the screen faces the driver DR and the third joint configuration and the disjointed configuration.

According to some preferred non-limiting embodiments, each manipulation element 12, 12′ comprises a handle 13, which is integral with the respective support element 9, 9′ and is arranged below the screen 10, 10′, namely below a lower side 14 of the screen 10, 10′ or on the opposite side with respect to the other screen 10′, 10 (as shown in FIGS. 2 to 4).

Preferably but without limitation, the handle 13 is made in one piece with the support element 9.

In particular, the handle 13 is obtained by means of a through opening 15 of the support element 9 configured to accommodate the hand of the driver DR and/or of the passenger P.

In the non-limiting embodiment of FIGS. 2 to 4, the through opening 15 has a symmetrical shape, delimited by a closed curve.

In other non-limiting embodiments not illustrated, the through opening 15 has an asymmetrical shape and/or is delimited by an open curve.

Preferably but without limitation, the opening 15 comprises two opposite rectilinear portions 16, connected to each other by two curvilinear portions 17, preferably circular (alternatively, as illustrated, the portions 17 can also be rectilinear, generating a rectangular through opening 15).

In particular, therefore, the movement system 11, without limitation, is a system with at least two degrees of freedom (given by respective hinges that slide inside the guide 18 for each support element 9, 9′).

Preferably but without limitation, the first screen 10 and the second screen 10′ are configured to provide a single image in the joint configuration and two distinct images in the disjointed configuration. In this way, in the joint configuration both the driver DR and the passenger P will be able to make use of more captivating content or in any case having more information given the substantially double display surface obtained by joining the screens 10 and 10′; on the other hand, in the disjointed configuration, the driver DR can access driving-related content in the screen arranged in the central portion 6 of the dashboard 4, while the passenger P can enjoy distracting content well away from the driver on the screen 10′ arranged in the lateral portion 6′ of the dashboard. In particular, the distracting content is enabled when a predefined distance is reached between the two screens 10 and 10′ (which, substantially, considerably reduces the risk of distracting the driver).

Advantageously but not necessarily, and as illustrated in the non-limiting embodiment of FIG. 3, the movement system 11 comprises at least one, preferably two, locking systems 30. The locking systems 30 are configured to keep in position the display device 5, namely each support element 9, 9′. In this way, it is possible to avoid abrupt repositioning (which can also harm the driver DR or the passenger P) of the display device 5 in the event of extreme vehicle dynamics (for example when braking i.e. suddenly decelerating before a curve) or, even worse, in the event of an accident.

In some non-limiting cases the locking system 30 is a mechanical system, comprising springs and/or dampers that allow only slow movements of the movement system 11.

In other non-limiting cases, the locking system 30 comprises a servomotor which, for example, allows movement of the movement system 11 (therefore sliding of the screens 10, 10′ along the guide 18) only below a certain vehicle speed or following an unlocking command by the driver DR.

In accordance with the above, preferably, the display device 5, in particular at the manipulation element 12, namely the handle 13, as illustrated in the non-limiting embodiment of FIG. 3, comprises at least an unlocking system 31, which allows the movement system 11 to be released from the locking system 30 to freely move the support element 9, 9′.

For example, advantageously but not necessarily, the unlocking system 31 is configured to enable the movement of the servomotors of the locking system 30 to move the support element 9 around the hinges along the transverse guide 18 illustrated in FIGS. 2 to 4.

According to some preferred non-limiting embodiments, the road vehicle 1 further comprises a control unit 20, which is configured to vary the contents shown by the display device 5 between the joint configuration in which the screen 10 is adjacent to the screen 10′ (namely they show one single shared content), and the disjointed configuration, in which the screen 10′ is separate from the screen 10 and is arranged substantially frontally to the passenger P.

In particular, in the joint configuration (for example illustrated in FIG. 4) the control unit 20 commands the screens 10, 10′ to show (jointly, as if they were one single screen) driving-related content, for example a circuit, the speed, lateral acceleration, lap time, etc. On the other hand, in the disjointed configuration (for example illustrated in FIG. 3) the control unit 20 commands the screen 10′ to show distracting content, such as videos, games, films etc. (while the screen 10 continues to show driving-related content for the driver DR).

Advantageously but not necessarily, in switching from the disjointed configuration to the joint configuration (or bringing the screens 10, 10′ together under the predefined distance), the distracting content is automatically disabled.

In use, during driving, the driver DR can move by means of the handle 13 the support element 9 and therefore the screen 10, thus bringing the latter closer to him (or coupling it with the support element 9′) and facilitate reading of the vehicle data, minimizing distraction, for example from the track. In the same way, the passenger P can move the screen 10′ closer to him (again using the handle) until it reaches the lateral portion 6′ of the dashboard 4 in front of him. During this passage, the control unit 20 enables the use of distracting content, preferably when the distance between the screens 10 and 10′ reaches a distance such as not to distract or at least such as to minimize distraction of the driver.

Although the invention described above makes particular reference to a precise embodiment example, it should not be considered limited to said embodiment example, since its scope includes all the variations, modifications or simplifications covered by the attached claims such as, for example, a different type of road vehicle (for example with front wheel drive), a different shape of the passenger compartment, different movement systems, a different type of screen, etc.

The vehicle and the display device described above have numerous advantages.

Firstly, they reduce distraction of the driver when viewing the vehicle data and information, and when using the mechanical controls.

Furthermore, at the same time, the passenger can be entertained with content that would otherwise be distracting for the driver and should therefore be generally precluded during driving.

In addition, driver safety is guaranteed, preventing the display device from knocking or injuring him in the event of an accident, or in any case moving from the optimal position found, for example, with the vehicle at a standstill; it would be particularly difficult to find said position again during movement of the vehicle, especially during a race.

Lastly, the movement system allows a combination of two different screens if necessary, via which the surface viewable by the driver can be doubled or can be diversified from the content that can be viewed by the passenger if the two screens are separated.

### LIST OF REFERENCE NUMBERS OF THE FIGURES

1 vehicle
2 wheels
3 passenger compartment
4 dashboard
5 display device
6 central portion
6′ lateral portion
7 driving position
8 passenger position
9 first support element
9′ second support element
10 first screen
10′ second screen
11 movement system
12 manipulation element
13 handle
14 lower side
15 opening
16 rectilinear portions
17 curvilinear portions
18 linear guide
20 control unit
30 locking systems
31 unlocking systems
A axis
D direction of travel
DR driver
F floor
P passenger
T transverse axis

1. A content display device (5) for a road vehicle (1); the content display device (5) comprising:
a first support element (9) configured to be mounted at a dashboard (4) of the road vehicle (1);
second support element (9′) configured to be mounted at the dashboard (4) in a position adjacent to the first support element (9);
a first screen (10), mechanically connected to the first support element (9) and configured to be visible to a passenger (P) and/or to a driver (DR) while driving;
a second screen (10′), mechanically connected to the second support element (9′) and configured to be visible to the passenger (P) and/or to the driver (DR) while driving;
the content display device (5) being characterized in that it comprises a movement system (11) mechanically coupled to the first support element (9) and to the second support element and configured to move the first screen (10) and/or the second screen (10′) between a joint configuration, in which the first screen (10) and the second screen (10′) are adjacent, and a disjointed configuration, in which the first screen (10) and the second screen (10′) are separated from each other.

2. The device (5) according to claim 1, wherein the movement system (11) comprises at least a guide (18) arranged at a surface (19) of the dashboard (4); the guide (18) extending transversely to a normal direction (D) of advancement of the road vehicle (1); the first support element (9) and the second support element (9′) being movably mounted and sliding along the guide (18).

3. The device according to claim 2, wherein the guide (18) is rectilinear and extends in a horizontal direction.

4. The device according to claim 1 and comprising at least a first manipulation element (12) mounted integral with the first support element (9) and/or a second manipulation element (12) mounted integral with the second support element (9); the first manipulation element (12) and/or the second manipulation element (12) being configured to be grasped by a hand of the driver (DR) and/or of the passenger (P) to move, in particular to translate, between each other the first screen (10) and/or the second screen (10′) at least between the joint configuration and the disjointed configuration.

5. The device according to claim 4, wherein the first manipulation element (12) and/or the second manipulation element (12′) comprise a respective handle (13), which is integral with respect to the first support element (9) and/or the second support element (9′) and is arranged below the first screen (10) and/or the second screen (10′) or on the side opposite the second screen (10′) and/or the first screen (10).

6. The device according to claim 5, wherein the respective handle (13) is made in one piece with the respective first support element (9) and/or second support element (9′).

7. The device according to claim 6, wherein the respective handle (13) is obtained by means of a through opening (15) of the respective support element (9) and is configured to accommodate the hand of the driver (DR) and/or of the passenger (P).

8. The device according to claim 1, wherein the first screen (10) and the second screen (10′) are configured to provide one single image in the joint configuration and two distinct images in the disjointed configuration.

9. A road vehicle (1) comprising
four wheels (2), of which at least one pair of wheels (2) is a pair of driving wheels;
a passenger compartment (3) configured to accommodate a driver (DR) and at least one passenger (P) alongside the driver (DR);
a vehicle dashboard (4);
the vehicle (1) being characterised in that it comprises a content display device (5) according to claim 1, wherein the movement system (11) is arranged at a central portion (6) of the vehicle dashboard (4), frontally between a driving position (7) and a passenger (P) position (8), and extends towards a lateral portion (6′), frontally to the passenger (P) position (8).

10. The road vehicle (1) according to claim 9, wherein the movement system (11) comprises at least a guide, preferably linear, integrated in the dashboard (4) of the road vehicle (1).

11. The vehicle (1) according to claim 9, wherein the movement system (11) is configured to translate the first support element (9) and/or the second support element (9′) along an axis substantially parallel with respect to a floor (F) of the road vehicle (1) and transverse to a normal direction of advancement of the road vehicle (1).

12. The vehicle (1) according to claim 9 and comprising a control unit (26), which is configured to vary the contents shown by the display device (5) between the joint configuration in which the screens (10, 10′) are adjacent, and the disjointed configuration in which the screens (10, 10′) are separated from each other.
